(19) United States
(12) Patent Application Publication
(10) Pub. No.: US 2011/0261695 A1
(43) Pub. Date: Oct. 27, 2011

(54) SYSTEM AND METHOD FOR NETWORK CONGESTION CONTROL

(76) Inventors: Xiaoming Zhao, Irving, TX (US); Xinhua Ling, Waterloo (CA)

(21) Appl. No.: 12/766,661

(22) Filed: Apr. 23, 2010

(51) Int. Cl. H04L 12/56

(52) U.S. Cl. 370/232

(57) ABSTRACT

A method for reducing congestion in a wireless communication network is presented. The method includes monitoring a congestion level of at least one network node of the network. When the congestion level is greater than a first threshold, the method includes initiating a first congestion control mechanism. When the congestion level is greater than a second threshold, the method includes initiating a second congestion control mechanism, the second threshold being greater than the first threshold. In some implementations, the first congestion control mechanism includes codec rate adaptation (CRA), and the second congestion control mechanism includes at least one of rejecting new service requests and dropping existing services. The method may include, after initiating the first congestion control mechanism, starting a timer and, when the timer reaches a pre-determined value and the congestion level is greater than the first threshold, initiating the second control mechanism.

### BACKGROUND

The present disclosure relates generally to a method for providing congestion control in a communication system and more specifically to a method for providing congestion control in universal terrestrial radio access network (UTRAN), evolved-UTRAN (E-UTRAN) and other packet-switched (PS) networks.

As used herein, the term “user equipment” (UE) can refer to a “mobile station” (MS), “user agent” (UA), or other devices that may include electronic devices such as fixed and mobile telephones, personal digital assistants (PDAs), handheld or laptop computers, smart phones, printers, fax machines, televisions, set-top boxes, and other video display devices, home audio equipment and other home entertainment systems, home control systems (e.g., home monitoring, alarm systems and climate control systems), enhanced home appliances such as computerized refrigerators and similar devices that have network communications capabilities. In some configurations, UE may refer to a mobile, wireless device. UE may also refer to devices that have similar capabilities but that are not readily transportable, such as desktop computers, set-top boxes, TVs, IPTVs and/or network nodes.

The term device or UE may also refer to a Session Initiation Protocol (SIP) User Agent (UA) that can be fixed or mobile. When a UA is a network node, the network node may act on behalf of another function, such as a UA or a fixed line device, and simulate or emulate the UA or fixed line device. For example, for some UAs, the Internet Protocol (IP) Multimedia Subsystem (IMS) SIP client that would typically reside on the device actually resides in the network and relays SIP message information to the device using optimized protocols. In other words, some functions that were traditionally carried out by a UE can be distributed in the form of a remote UE, where the remote UE represents the UE in the network.

Generally, the terms “user agent,” “UA,” “user equipment, “UE,” and “node” may be used synonymously herein. Those skilled in the art will appreciate that these terms can be used interchangeably within the application.

A UE may operate in a wireless communication network that provides high-speed data communications using various network configurations and/or Radio Access Technologies (RATs). For example, the UE may operate in accordance with Global System for Mobile Communications (GSM) and General Packet Radio Service (GPRS) technologies. A UE may further operate in accordance with various network implementations such as universal terrestrial radio access network (UTRAN), evolved-UTRAN (E-UTRAN), enhanced data rates for GSM evolution (EDGE), enhanced GPRS (EGPRS) or enhanced GPRS phase 2 (EGPRS2). Some UEs may be capable of multimode operation where they can operate on more than one access network technology either on a single access network at a time or, in some devices, using multiple access technologies simultaneously.

In wireless telecommunications systems, transmission equipment in a base station transmits signals throughout a geographical region known as a cell. As technology has evolved, more advanced equipment has been introduced that can provide services that were not possible previously. The advanced equipment might include, for example, an E-UTRAN node B (eNB) rather than a base station or other systems and devices that are more highly evolved than the equivalent equipment in a traditional wireless telecommunications system. Such advanced or next generation equipment may be referred to herein as long-term evolution (LTE) equipment, and a packet-based network that uses such equipment can be referred to as an evolved packet system (EPS). As used herein, the term “access device” may refer to any component, such as a traditional base station, eNB, or other LTE access device, that can provide a UE with access to other components in a telecommunications system.

In Third Generation Partnership Project (3GPP) systems, voice services can be provided by a mobile operator by a series of means. Over GPRS/EDGE Radio Access Network (GERAN) and Universal Terrestrial Radio Access Network (UTRAN), for example, Circuit Switched (CS) infrastructure may be used to provide voice services. Alternatively, over UTRAN and E-UTRAN, an EPS infrastructure can be used for PS communications.

FIG. 1 is an illustration of an exemplary architecture of an EPS system configured for 3GPP access. UE 10 is configured to communicate via E-UTRAN 12. When communicating with E-UTRAN 12, UE 10 may use the LTE-Uu interface, for example. E-UTRAN 12, in turn, is configured to communicate with mobile management entity (MME) 14 and serving gateway 16. MME 14 facilitates communications between E-UTRAN 12 and serving gateway 16. To perform its function, MME 14 may access Serving GPRS Support Node (SGSN) 18 and home subscriber server (HSS) 20.

Serving gateway 16 may be configured to operate as a gateway to UTRAN 22 and/or GERAN 24 and is in communication with SGSN 18. Serving gateway 16 is also in communication with packet data network (PDN) gateway 26. PDN gateway 16 is, in turn, connected to the network operator's IP services 30, which may include IMS and PSS, for example. PDN gateway 16 is also in communication with policy and charging rules function (PCRF) 28, which can manage bandwidth and route allocation, in addition to charging rates and security.

In UTRAN, E-UTRAN, or other networks it may be necessary to provide a mechanism for congestion control. If the load on the network becomes excessive, traffic on the network becomes congested and the network users may experience severe performance degradation. In the case of on-going communications (e.g., communications occurring on communication channels that were established before the congestion began), the communications may be interrupted, particularly if the communications use a relatively large amount of bandwidth (e.g., video-conferences or other video communications). If the network is severely congested, the video communications may be interrupted resulting in decreases in frame rate, possibly causing significant pauses in the communications. In the case of voice communications, congestion may cause the voice call quality to deteriorate and the service to be interrupted, possibly significantly. In a congested network, requests for new communication channels (e.g., initiation of a voice or video conference call) may be significantly delayed, again resulting in a negative user experience. If the congestion is sufficiently detrimental, requests for new communications may fail entirely.

As the network detects that it is becoming congested, one or more congestion control mechanisms may be initiated to minimize an amount of network traffic being generated by each of the connected devices, thereby mitigating the congestion condition. The congestion control mechanisms may require, for example, that each connected device (e.g., one or more UEs) begin transmitting and receiving data at a lower quality thereby using less bandwidth, or that particular services (e.g., the video portion of a video conference call) be abandoned entirely. There are several existing mechanisms for providing congestion control. The mechanisms include network initiated quality of service (QoS) modification based on a service admission and retention policy (ARP), codec rate adaptation (CRA), base station load balancing, etc. By definition in 3GPP TS23.203 on Policy and Charge Control Architecture, the QoS parameter ARP contains information about the priority level, the pre-emption capability and the pre-emption vulnerability. The priority level defines the relative importance of a resource request. This allows for deciding whether a bearer establishment or modification request can be accepted or whether the request needs to be rejected due to resource limitations. It can also be used to decide which existing bearers to pre-empt during resource limitations. The range of the ARP priority level is 1 to 15 with 1 as the highest level of priority. The preemption capability information defines whether a service data flow can get resources that were already assigned to another service data flow with a lower priority level. The pre-emption vulnerability information defines whether a service data flow can lose the resources assigned to it in order to admit a service data flow with higher priority level. The pre-emption capability and the pre-emption vulnerability can be either set to ‘yes’ or ‘no’. For simplicity of discussion, it may be assumed that both pre-emption capability and pre-emption vulnerability are set to values of “yes”.

Under congestion, the network may implement congestion control mechanisms in an attempt to mitigate the congestion condition. In many cases, a threshold level of congestion must be reached before the congestion control mechanisms are initiated. If the congestion control trigger thresholds are the same for each congestion control mechanism, multiple ones of the congestion control mechanisms may be initiated at the same time (e.g., when the network reaches 80% congestion, all available congestion control mechanisms are activated). In some cases, however, when multiple congestion control mechanisms are initiated at the same time, the operation of the different mechanisms conflict, with one congestion mechanism negatively affecting the operation and performance of another congestion mechanism.

For example, a network may be configured to implement two congestion reduction schemes: a CRA scheme and a conventional congestion control (CCC) scheme. The CRA scheme causes connected devices to reduce their codec rate resulting in less bandwidth use per communication channel, but with lower-quality communications. As such, the CRA scheme may allow for the ongoing use of existing communication channels and services, only at a lower codec rate. In contrast, the conventional congestion scheme causes the network to drop or deny requests for services that consume large amounts of bandwidth (e.g., video). By dropping the high-bandwidth-consuming services, network congestion is minimized. Accordingly, if both the CRA and conventional congestion scheme are implemented at the same time, their operation will conflict. The CRA scheme attempts to minimize network traffic while allowing use of all available services on the network. Meanwhile, the conventional congestion control scheme works against the CRA scheme by denying requests for the very same services (e.g., high-bandwidth services) that the CRA scheme is configured to preserve. In a similar fashion, other congestion control mechanisms may interfere with one another.

Accordingly, there is a need for a system and method to deploy congestion control mechanisms so as to minimize an amount of interference or conflict resulting from the deployed congestion control mechanisms. And, more generally, there is a need for a congestion control deployment system that allows for a prioritization scheme to be developed to control the order and threshold triggers upon which particular congestion control mechanisms are implemented.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an illustration of an exemplary architecture of an EPS system configured for 3GPP access;

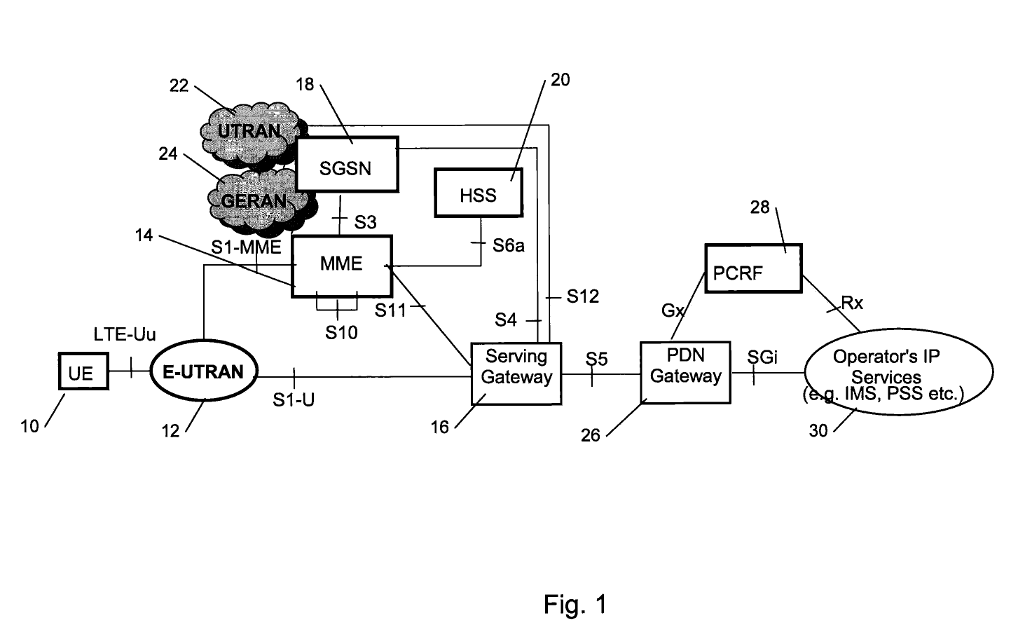

FIG. 2 is an illustration showing several candidate network nodes and associating each network node with congestion control mechanisms suited to mitigate congestion of the network node;

FIG. 3 illustrates a wireless communications system including an embodiment of the user agent;

FIG. 4 shows a block diagram of the user agent including a digital signal processor (DSP) and a memory;

FIG. 5 illustrates a software environment that may be implemented by a processor of a user agent; and

FIG. 6 illustrates an example of a system that includes a processing component suitable for implementing a method for providing continuity for sessions transitioning between networks.

### DETAILED DESCRIPTION

The present disclosure relates generally to a method for providing congestion control in a communication system and, more specifically, to a method for providing congestion control in universal terrestrial radio access network (UTRAN), evolved-UTRAN (E-UTRAN) and other packet-switched (PS) networks.

To this end, some embodiments include a method for reducing congestion in a wireless communication network. The method includes monitoring a congestion level of at least one network node of the network, and, when the congestion level is greater than a first threshold, initiating a first congestion control mechanism. The method includes, when the congestion level is greater than a second threshold, initiating a second congestion control mechanism. The second threshold is greater than the first threshold.

Other embodiments include a method for reducing congestion in a wireless communication network. The method includes monitoring a congestion level of at least one network node of the network, and, when the congestion level is greater than a first threshold, initiating a first congestion control mechanism, and starting a first timer. When the first timer reaches a first pre-determined value and the congestion level is greater than a second threshold, the method includes initiating a second congestion control mechanism. The second threshold is less than the first threshold.

Other embodiments include a base station for reducing congestion in a wireless communication network. The base station includes a processor configured to monitor a congestion level of at least one network node of the network, and, when the congestion level is greater than a first threshold, initiate a first congestion control mechanism. When the congestion level is greater than a second threshold, the processor is configured to initiate a second congestion control mechanism. The second threshold is greater than the first threshold.

Other embodiments include a user equipment for reducing congestion in a wireless communication network. The user equipment includes a processor configured to, when a congestion level of at least one network node of the network is greater than a first threshold, implement a first congestion control mechanism. When the congestion level is greater than a second threshold, the processor is configured to implement a second congestion control mechanism. The second threshold is greater than the first threshold.

The various aspects of the disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (for example, hard disk, floppy disk, magnetic strips, and the like), optical disks (for example, compact disk (CD), digital versatile disk (DVD), and the like), smart cards, and flash memory devices (for example, card, stick, and the like). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

When a communications network detects that the network is becoming congested, one or more congestion control mechanisms may be initiated to minimize an amount of network traffic being generated by each of the devices connected to, and communicating via the network. The congestion control mechanisms may require that each device begin transmitting and receiving data at a lower quality, or that particular services (e.g., the video portion of a video conference call) be abandoned entirely. There are several mechanisms for providing congestion control.

Conventional congestion control mechanisms can be used to temporarily deny use of particular services on the network. The services may include voice, video, data, or other communication services, for example. The conventional congestion control mechanisms may cause requests for particular services to be rejected or cause the removal of support for existing services. By removing, denying the use of, or dropping particular services, the QoS levels for the remaining services can be maintained.

The conventional congestion control mechanisms are generally controlled by using the level of ARPs associated with a particular bearer in eUTRAN or a PDP context in UTRAN (e.g., a service). The ARP determines whether a bearer establishment or bearer modification request relating to a particular service is to be accepted or whether the request is to be rejected due to resource limitations (e.g., limitations based upon the typically available radio capacity required for guaranteed bit rate (GBR) bearers). Priority level information of the ARPs can be used to create a priority ordering for different bearers and may be used to determine whether particular service requests are accepted. Accordingly, requests for bearers with a higher priority level are generally preferred and accepted over requests for lower priority bearers.

The ARP can also be used to determine which bearer(s) to drop during exceptional resource limitations (e.g., at handover). For example, in the case of video telephony it can be beneficial to allocate each EPS bearer (e.g., the individual voice bearer and video bearer elements of the video telephone call) different ARP values for the same UE. In that case, an operator can map the voice bearer to a first bearer with a higher priority level ARP, and the video bearer to a second bearer with a lower priority level ARP. In a congestion situation (e.g., cell edge) the network will then drop or implement congestion control mechanisms on the video bearer first without affecting the voice bearer to improve service continuity.

In conventional congestion control, the ARP can also be used to free up capacity in exceptional circumstances, e.g., a disaster situation. In such a case, the network may drop all bearers with lower than a particular ARP priority level to free-up additional network capacity. Therefore, when the network experiences exceptional levels of congestion, the QoS of the higher priority services can be maintained by dropping lower priority services.

A second congestion control scheme, network initiated QoS modification based on service admission and rejection policy adaptation, may be used to reduce the GBRs of the GBR bearers/packet data protocol (PDP) contexts to mitigate network congestion. Using this scheme, when experiencing base station and/or other core network element congestion, the QoS parameter values of the active services are lowered to free up network capacity. In one example implementation of this scheme, the packet data network gateway (PGW) initiated bearer modification with QoS parameter update procedure described in subclause 5.4.2.1 of TS23.401 (3GPP TS23.401 GPRS enhancements for E-UTRAN access) can be used for such a purpose to implement the dynamic policy and charging control (PCC) rules made by the policy and charging rules function (PCRF) according to network resource usage reports.

CRA may also be used to ease congestion and to allow more simultaneous services by reducing the effective QoS of particular services. Using CRA, a base station may control the initial codec rate selection and/or to trigger a codec rate reduction for connected UEs or other devices. As such, a base station (e.g., an eNB) can increase capacity (e.g., in terms of a number of accepted VoIP calls), and improve coverage (e.g., for high bit rate video sessions). When the base station experiences congestion, the codec rates may be reduced and the effective QoS for the active services can be lowered to free up capacity though the QoS parameter values are not changed. In one example, when experiencing congestion, the base station may initiate CRA by causing connected UEs to reduce their initial (or ongoing) codec rate selection, thereby implementing CRA.

Base station (e.g., eNodeB) load balancing (see, for example, section 11.1.6 of TS36.300 3GPP TS36.300 E-UTRA and E-UTRAN Overall Description) can also be used to mitigate network congestion. Base station or network load balancing can be used to handle uneven distribution of traffic load over multiple network cells. Load balancing can be used to redistribute network load so that radio resources within the network remain highly utilized and the QoS of existing sessions are maintained to the extent possible. This similarly minimizes the likelihood of call or session dropping. Load balancing algorithms may cause hand-over or cell reselection decisions to redistribute traffic from highly loaded cells to underutilized cells. Using load balancing, the QoS of active services can be maintained by redistributing services among the cells of the same base station or amongst several different base stations.

Another congestion control mechanism includes selective IP flow traffic offloading (SIPTO) (see, for example, TR23.829 Local IP Access and Selected IP Traffic Offload). Using this congestion control mechanism, a portion of the core network traffic can be offloaded from the core packet gateways to alternative local gateways. After offloading to the local gateways, the QoS enforcement made by the local gateways may not be under the core network control. As a result, the service QoS via the local connections may differ from that of core connection.

With specific reference to 3GPP networks, encoder selection and rate adaptation congestion control mechanisms may be made available for UTRAN and E-UTRAN. The encoder selection and rate adaptation mechanisms may be used by network operators to provide efficient mechanisms for codec rate control based upon a network's current load condition. These mechanisms may allow a network operator to increase a network's capacity while limiting the quality (i.e., allocated bandwidth) for both voice and non-voice communications. Alternatively, a network operator may use these mechanisms to increase both quality of voice and non-voice communications while limiting the network's overall capacity for simultaneous communications.

Using CRA congestion control mechanism, the congested network node (e.g. an eNodeB, or eNB, NodeB, or NB) can be configured to set a Congestion Experienced (CE) codepoint or signal (e.g., a codepoint of ‘11’) in the protocol headers of messages communicated by that network node (either in the downlink or uplink direction). The CE signal is used to indicate that the network node is experiencing congestion. After receiving the CE signal, devices using that network node can use the codepoint to control codec rate selection and/or to trigger a codec rate reduction at call setup or during the call to minimize network traffic generated by the device. Accordingly, the network node can communicate its current congestion condition, allowing the connected devices to respond accordingly. Note that many different codepoints may be defined on a particular network to indicate network congestion and/or to initiate different congestion control mechanisms.

In such a network implementation, the CE signal propagates to the receiving internet protocol (IP) end-point and can be made available to the media or application layer receiver by the recipient device. After receiving the CE signal, the receiver can then send an application layer rate reduction message (e.g., via real time control protocol (RTCP)) to request a new send rate from the corresponding sender application.

Within a network, certain triggers can be established to define when to initiate one or more congestion control mechanisms. For example, the threshold may be defined as a particular level of congestion (e.g., 80%) upon which one or more congestion control measures can be initiated. Each congestion control measure, however, operates differently and, when initiated at the same time as other congestion measures, may interfere with one another. For example, congestion measures that affect codec rate can conflict directly with congestion measures that deny access to particular services, as described above.

The present system allows for prioritization of congestion control schemes. In one implementation, the prioritization may be used to compensate for potentially conflicting characteristics of different available congestion control mechanisms. In the present system, each of the available congestion control mechanisms is associated with one or more rules or tests that define the conditions upon which a particular congestion control mechanism is to be initiated. By associating each mechanism with different rules and/or triggers, the network can control the order in which the different congestion control mechanisms are initiated and the network conditions or timing that cause each mechanism to be initiated. As such, conflicts between different congestion control mechanisms that have different objectives can be minimized. Furthermore, certain catastrophic congestion conditions can be defined and, given such a condition, the network may reject all new incoming calls, or may even drop existing calls.

For example, in one example network, when both conventional congestion control and CRA congestion control mechanisms are active to support more simultaneous services while preventing catastrophic system behavior due to congestion, the present system may be configured to associate the available congestion control mechanisms with different trigger rules so that both mechanisms are not initiated at the same time and do not interfere with one another. When CRA has been triggered (for example, using Explicit Congestion Notification (ECN) or any other codec adaptation trigger mechanism), but has not mitigated the congestion condition within a specified time period, using the present system, a conventional congestion control mechanism (as described above) may be initiated to reject new service requests or to drop various service bearers according to the ARP. One or more of the congestion control mechanisms may be triggered by the network.

The congestion control mechanism priority setting of the present system may take into account the objective priorities of the congestion control mechanisms to minimize interference between control mechanisms. For example, in one implementation, when a network experiences congestion, the congestion control mechanisms that allow more services with lower QoS may have a higher priority than congestion control mechanisms that maintain a particular level of QoS while allowing fewer services. As such, if the codec rates for voice and video calls are set at their lowest level and the network still experiences congestion, the present system may be used to specify that the next step is for the network to begin dropping calls.

In some cases, the present prioritization of congestion control mechanisms may be achieved by setting different levels of congestion detection thresholds for each mechanism. The thresholds may be selected so that the conventional congestion control uses a higher level congestion detection threshold than that of CRA congestion control, for example. In that case, the network would first engage CRA and, if that congestion control mechanism fails to mitigate the problem, the network may go on to initiate conventional congestion control, for example. Accordingly, multiple congestion level thresholds can be defined for each congestion control mechanism. At the highest level of congestion, the network may be configured to reject and release all calls. Alternatively, the network may be configured to only reject calls and is not required to release all calls.

Table 1 is an illustration of an example priority listing of congestion control mechanisms available to a network in accordance with the present disclosure. As shown in the table, the example network is configured to implement two control mechanisms: CRA and conventional call drop or removal. Each mechanism is assigned a different priority, with CRA being assigned a priority of ‘1’, while conventional call drop or removal is assigned a priority of ‘2’. As shown in Table 1, CRA is configured to be implemented when the network reaches 80% utilization. The CRA control mechanism will stay in effect until the network utilization falls below 75% at which point the control mechanism is terminated.

TABLE 1

| | | | | Timer to Start next |
|---|---|---|---|---|
| Congestion | | | | Priority |
| Control | | Threshold | Threshold | Congestion |
| Mechanism | Priority | to Start | to Stop | Control after start |
| codec | 1 | 80% | 75% | 300 sec |
| adaptation | | resource | resource | |
| | | usage | usage | |
| conventional | 2 | 85% | 80% | N/A |
| call drop or | | resource | resource | |
| removal | | usage | usage | |

Within Table 1, a timer value is also defined for the CRA control mechanism. Upon initiation of the CRA control mechanism, a timer is started. When the timer expires or reaches the defined timer value (in this example, the timer expires after 300 seconds), if the congestion condition has not been mitigated (e.g., network utilization has not fallen below 75%), the next control mechanism having the next highest priority level is executed. Accordingly, in this example, upon expiration of the timer and if network congestion has not fallen below 75%, the conventional call drop or removal congestion control mechanism would be initiated by the network.

Additional start and stop thresholds are also defined for the remaining congestion control mechanisms. In this example, the conventional call drop or removal control mechanism is automatically initiated if network utilization goes above 85% and is stopped when the network utilization falls below 80%.

In the example shown in Table 1, because there are only two congestion control mechanisms, no timer is associated with the second control mechanism as there would be no third mechanism to execute if the timer for the conventional call drop or removal congestion control mechanism expires. Accordingly, in many implementations of the present system, a timer value will be defined for all but one of the control mechanisms (i.e., the mechanism with the lowest priority will not have a defined timer value).

In alternative implementations, Table 1 may be modified to remove one or more columns. For example, only the congestion control mechanism having a priority of ‘1’ may have start and stop thresholds. In that case, the other congestion control mechanisms would not have associated thresholds. Instead, timers would be defined allowing the remaining congestion control mechanisms to be executed in accordance with those timer values, as described above. In that case, after the network reaches the threshold defined for the first congestion control mechanism, the remaining congestion control mechanisms are initiated after their associated timers expire. Alternatively, the present system may be implemented with no timer values. In that case, each of the available congestion control mechanisms would be controlled by the defined threshold values for each control mechanism.

In accordance with the present disclosure, a priority listing similar to those shown in Table 1 can be defined for any of the congestion control mechanisms that are available to a network. The congestion control mechanisms may include those described above, or other mechanisms that are used to control congestion in a network. Furthermore, any data available to the network may be used in defining the thresholds. For example, a threshold may be defined based upon a combination of factors such as network resource use, number of connected devices, subscription plans of the connected devices, time of day, external conditions (e.g., a catastrophic event such as earthquake, storm or violent attack), etc.

In addition to prioritization levels, different congestion control mechanisms can be classified according to the types of congested network nodes and/or network devices to which the control mechanisms provide the most benefit. These characterizations may then be used to identify the most appropriate congestion control mechanism when a particular network node is experiencing a majority of the congestion. For example, the network initiated QoS modification and the SIPTO congestion control mechanisms may be primarily effective in mitigating congestion within core network nodes such as the PGW. In contrast, the codec adaptation and eNodeB load balancing congestion control mechanisms mitigate congestion in access network nodes.

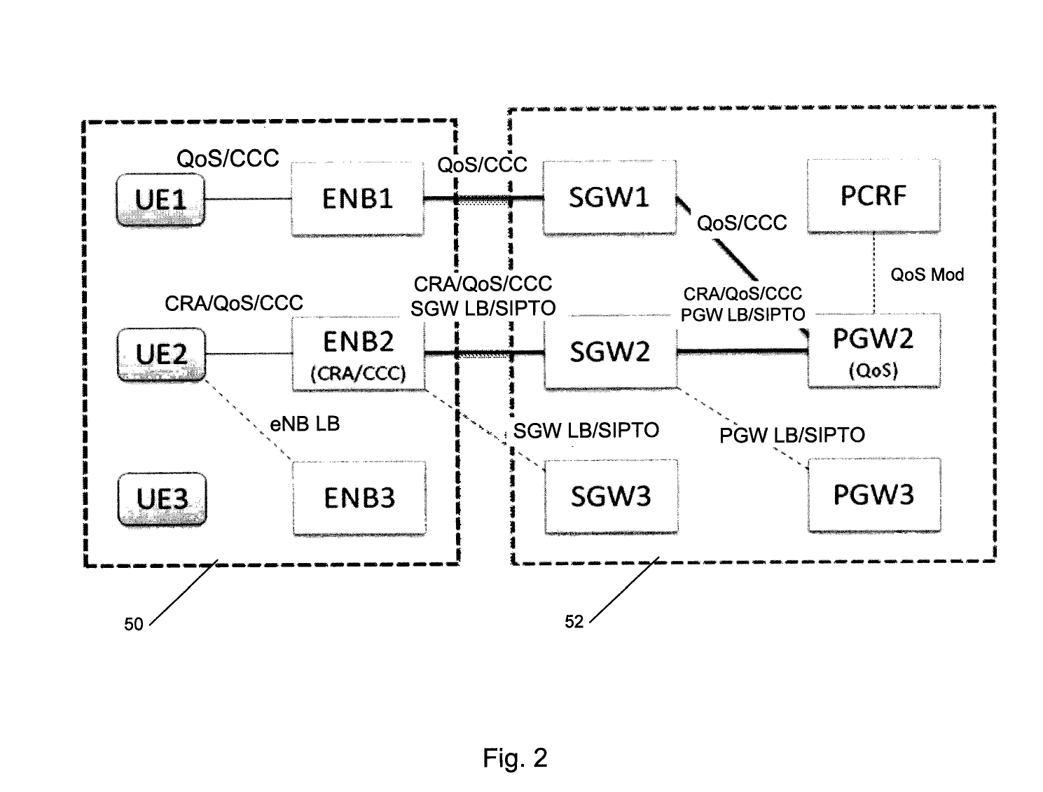

FIG. 2 is an illustration showing several candidate network nodes and associating each network node with congestion control mechanisms suited to mitigate congestion of the network node. FIG. 2 is intended to illustrate the possible relationships between different network components, and associate each component with particular congestion control mechanisms. As shown in FIG. 2 several UEs (e.g., UE1, UE2 and UE3) can be in communication with several base stations (e.g., eNB1, eNB2, and eNB3). The UEs and base stations are grouped as part of access network 50 and may be nodes within access network 50. Also shown in FIG. 2, several serving gateways (SGWs) (e.g., SGW1, SGW2, and SGW3) can be in communication with the base stations and PGWs (e.g., PGW1, and PGW2) and PCRF. The SGWs, PGWs and PCRF are grouped as part of core network 52 and are nodes within core network 52.

As shown in FIG. 2, eNB capacity is primarily benefited by congestion control mechanisms including CRA, conventional congestion control (CCC), QoS modification (QoS), and eNB or base station load balancing (eNB LB). The core network element SGW is primarily benefited by congestion control mechanisms including CRA, QoS, CCC, SGW load balancing and SIPTO. The core network element PGW is primarily benefited by congestion control mechanisms including CRA, QoS, CCC, PGW load balancing, and SIPTO. Though CRA provides some benefits to SGW and PGW, CRA may be used for congestion control of a specific eNB. As such, CRA can be classified for access network congestion control. In comparison, QoS modification and PGW load balancing may provide more improvements to PGW capacity. As such, QoS modification and PGW load balancing can be classified as the primary control mechanisms for PGW congestion control.

With the congestion control mechanisms classified based upon the network nodes to which the control mechanism provides the primary benefit, the priority listing of Table 1 can be used by a network to provide targeted congestion control. If congestion is occurring in a particular network node or collection of nodes, priority may be given to those congestion control mechanisms that provide the most benefit to the particular network node or collection of nodes experiencing congestion.

In some cases, codec adaptation using ECN for congestion control can be applied to both voice and non-voice calls. In that case, if CRA is implemented, both voice and non-voice calls may be affected to the same degree. This behavior, however, may not be optimal. For example, it may not be desirable to apply the CRA for voice and non-voice call types simultaneously and equally. Voice calls generally require less bandwidth than video conferencing because video conferencing combines both video data and audio data. Accordingly, when congestion occurs, it may be more effective to apply the congestion control mechanism only to the video communications (or primarily to video communications) before affecting the voice communications if the congestion is not minimized.

Also, for call types to which CRA is applicable, it may not always be desirable to apply codec adaptation to all the types starting at the same time. As an example, for video conferencing that includes both video data and audio data, under congestion, the video codec rate can be reduced while maintaining the audio codec rate. Because the video portion of a video conference may be less important than the audio portion, it may be of primary importance to maintain the audio QoS or the audio codec rate. Note that in this discussion a call type may also be a service type (e.g., a voice call is also a voice service). In some cases, however, a service type may not be a call type. For example, a service such as call independent supplementary service (CISS) which the user uses the service to setup the call transfer number(s) or to enable a call transfer is not a call. As such, the routing area update, for example, is a service but not a call.

Accordingly, for a call type or service type to which CRA is applied, it may not always be desirable to apply codec adaptation to 100% of the calls associated with the call or service type. For example, at a first time the network may be congested with, primarily, video services. In that case, it may be determined that CRA only needs to be applied to a subset of the ongoing video services to mitigate the congestion condition. Therefore, in the present system, for CRA based congestion control mechanisms, the ECN Application Call Type (ECAT) indicator (or any other appropriate indicator) is modified to indicate to what call type(s) (e.g., voice, non-voice, or both) the congestion control is to be applied. In one implementation of the present system, in 3GPP release 9 networks the modified CRA only applies to voice services. For 3GPP release 10 and later networks, however, the modified CRA may apply to both voice and non-voice services.

The ECAT (or other appropriate) indicator can include a scalar value. For example, the indicator may include a two bit field for indicating any of the values of 0, 1, 2, or 3. The value of the indicator may then be used to indicate to what services the CRA is applied (e.g., 0 indicates “none applicable”, 1 indicates “voice call applicable”, 2 indicates “non-voice call applicable”, and 3 indicates “both voice and non-voice calls applicable”). For example, Table 2 illustrates an example information element (IE) for providing the CRA application type indicator. As shown, the indicator can take values of 0, 1, 2, or 3 that respectively indicate that the codec rate adaptation should be applied to no services, voice services, non-voice services, or both voice and non-voice services.

TABLE 2

| | | | IE Type and | Semantics |
|---|---|---|---|---|
| IE/Group Name | Presence | Range | Reference | Description |
| CRA Application | M | 0, 1, 2, 3 | Integer | 0 = none, |
| Type Indicator | | | | 1 = voice, |
| | | | | 2 = non-voice, |
| | | | | 3 = voice and |
| | | | | non-voice |

Each call type or service type (which can be identified from application layer call/service setup signaling) to which congestion control using CRA may be applied can also be associated with an ECN Application Priority (EAPr) indication or other appropriate priority indication. The EAPr can be used to indicate a priority of the call type or service type for codec adaptation. Generally, CRA is applied to the services having the higher EAPr values first. If the congestion continues, CRA can then be applied to services with lower EAPrs.

Using the EAPr, the CRA congestion control mechanism can be applied to various services at different levels of congestion based upon the EAPr associated with that service. Accordingly, if video services have a higher EAPr than voice services, when a network first becomes congested, CRA is performed on the video services first. If the congestion continues, CRA is applied to the service having the next lowest EAPr—in this case the voice services.

If no EAPr values are specified within the system, the default EAPr for all the call types and services may be set to equal values. Notice that the EAPr may be used for the CRA method to allow CRA application to the call/service types in a priority order when CRA is not applied to all the call/service types at the same time, depending on the degree of the congestion. It is expected that if the congestion condition is not relieved when CRA is applied to all the voice and non-voice services, additional congestion control mechanisms such as conventional congestion control mechanism(s) may be initiated.

For each call type or service type applicable for congestion control using CRA, the call type of service type may be associated with an ECN Application Percentage (EAP) indication. The EAP indicates the percentage of the calls of the call type or service type to which codec adaptation is to be applied. By selecting an appropriate EAP, network operators can fine tune the network's congestion response. In one implementation, the default EAP for each of the call types or services is set to 100 percent. The EAP indications can be system parameters configurable by the operator on the network entity (e.g. eNB).

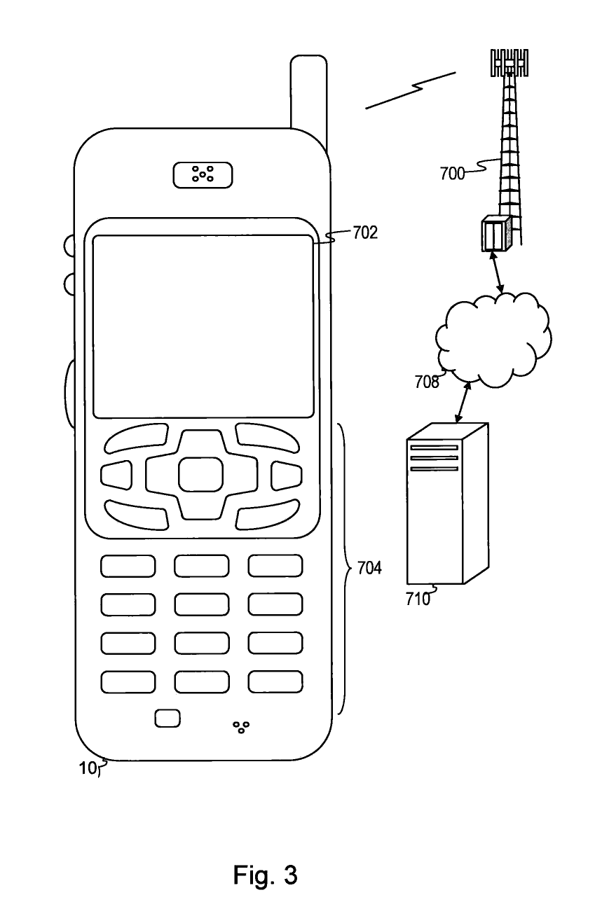

Referring now to FIG. 3, a wireless communications system including an embodiment of an exemplary UE 10 is illustrated. The UE is operable for implementing aspects of the disclosure, but the disclosure should not be limited to these implementations. Though illustrated as a mobile phone, the UE may take various forms including a wireless handset, a pager, a personal digital assistant (PDA), a portable computer, a tablet computer, a laptop computer, smart phones, printers, fax machines, televisions, set top boxes, and other video display devices, home audio equipment and other home entertainment systems, home monitoring and control systems (e.g., home monitoring, alarm systems and climate control systems), and enhanced home appliances such as computerized refrigerators. Many suitable devices combine some or all of these functions. In some embodiments of the disclosure, the UE 10 is not a general purpose computing device like a portable, laptop or tablet computer, but rather is a special-purpose communications device such as a mobile phone, a wireless handset, a pager, a PDA, or a telecommunications device installed in a vehicle. The UE 10 may also be a device, include a device, or be included in a device that has similar capabilities but that is not transportable, such as a desktop computer, a set-top box, or a network node. The UE 10 may support specialized activities such as gaming, inventory control, job control, and/or task management functions, and so on.

The UE 10 includes a display 702. The UE 10 also includes a touch-sensitive surface, a keyboard or other input keys generally referred as 704 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a track wheel, an exit or escape key, a trackball, and other navigational or functional keys, which may be inwardly depressed to provide further input function. The UE 10 may present options for the user to select, controls for the user to actuate, and/or cursors or other indicators for the user to direct.

The UE 10 may further accept data entry from the user, including numbers to dial or various parameter values for configuring the operation of the UE 10. The UE 10 may further execute one or more software or firmware applications in response to user commands. These applications may configure the UE 10 to perform various customized functions in response to user interaction. Additionally, the UE 10 may be programmed and/or configured over-the-air, for example from a wireless base station, a wireless access point, or a peer UE 10.

Among the various applications executable by the UE 10 is a web browser, which enables the display 702 to show a web page. The web page may be obtained via wireless communications with a wireless network access node, a cell tower, a peer UE 10, or any other wireless communication network or system 700. The network 700 is coupled to a wired network 708, such as the Internet. Via the wireless link and the wired network, the UE 10 has access to information on various servers, such as a server 710. The server 710 may provide content that may be shown on the display 702. Alternately, the UE 10 may access the network 700 through a peer UE 10 acting as an intermediary, in a relay type or hop type of connection.

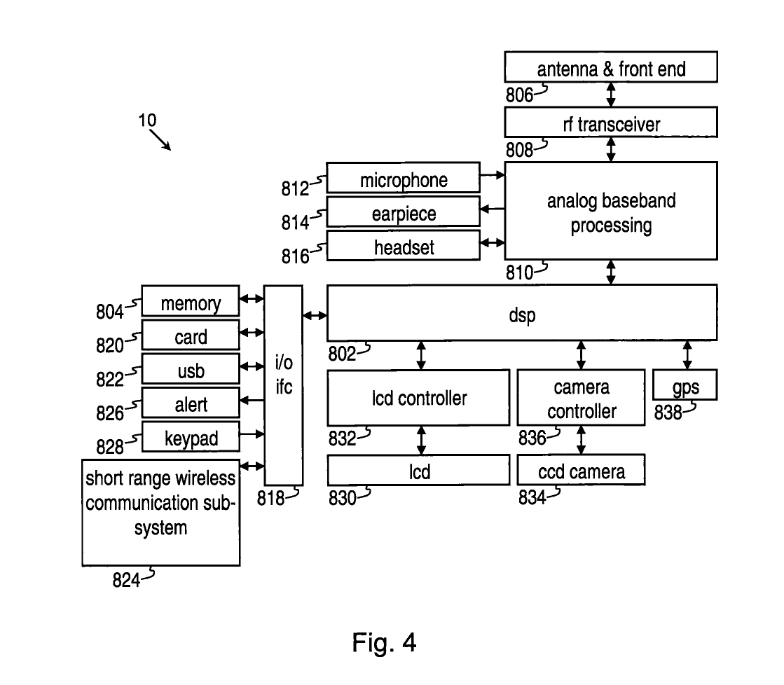

FIG. 4 shows a block diagram of the UE 10. While a variety of known components of UAs 10 are depicted, in an embodiment a subset of the listed components and/or additional components not listed may be included in the UE 10. The UE 10 includes a digital signal processor (DSP) 802 and a memory 804. As shown, the UE 10 may further include an antenna and front end unit 806, a radio frequency (RF) transceiver 808, an analog baseband processing unit 810, a microphone 812, an earpiece speaker 814, a headset port 816, an input/output interface 818, a removable memory card 820, a universal serial bus (USB) port 822, a short range wireless communication sub-system 824, an alert 826, a keypad 828, a liquid crystal display (LCD), which may include a touch sensitive surface 830, an LCD controller 832, a charge-coupled device (CCD) camera 834, a camera controller 836, and a global positioning system (GPS) sensor 838. In an embodiment, the UE 10 may include another kind of display that does not provide a touch sensitive screen. In an embodiment, the DSP 802 may communicate directly with the memory 804 without passing through the input/output interface 818.

The DSP 802 or some other form of controller or central processing unit operates to control the various components of the UE 10 in accordance with embedded software or firmware stored in memory 804 or stored in memory contained within the DSP 802 itself. In addition to the embedded software or firmware, the DSP 802 may execute other applications stored in the memory 804 or made available via information carrier media such as portable data storage media like the removable memory card 820 or via wired or wireless network communications. The application software may comprise a compiled set of machine-readable instructions that configure the DSP 802 to provide the desired functionality, or the application software may be high-level software instructions to be processed by an interpreter or compiler to indirectly configure the DSP 802.

The antenna and front end unit 806 may be provided to convert between wireless signals and electrical signals, enabling the UE 10 to send and receive information from a cellular network or some other available wireless communications network or from a peer UE 10. In an embodiment, the antenna and front end unit 806 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 806 may include antenna tuning and/or impedance matching components, RF power amplifiers, and/or low noise amplifiers.

The RF transceiver 808 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 810 and/or the DSP 802 or other central processing unit. In some embodiments, the RF transceiver 808, portions of the antenna and front end 806, and the analog baseband processing unit 810 may be combined in one or more processing units and/or application specific integrated circuits (ASICs).

The analog baseband processing unit 810 may provide various analog processing of inputs and outputs, for example analog processing of inputs from the microphone 812 and the headset 816 and outputs to the earpiece 814 and the headset 816. To that end, the analog baseband processing unit 810 may have ports for connecting to the built-in microphone 812 and the earpiece speaker 814 that enable the UE 10 to be used as a cell phone. The analog baseband processing unit 810 may further include a port for connecting to a headset or other hands-free microphone and speaker configuration. The analog baseband processing unit 810 may provide digital-to-analog conversion in one signal direction and analog-to-digital conversion in the opposing signal direction. In some embodiments, at least some of the functionality of the analog baseband processing unit 810 may be provided by digital processing components, for example by the DSP 802 or by other central processing units.

The DSP 802 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 802 may perform modulation, coding, interleaving, and spreading, and for a receiver function the DSP 802 may perform despreading, deinterleaving, decoding, and demodulation. In another embodiment, for example in an orthogonal frequency division multiplex access (OFDMA) technology application, for the transmitter function the DSP 802 may perform modulation, coding, interleaving, inverse fast Fourier transforming, and cyclic prefix appending, and for a receiver function the DSP 802 may perform cyclic prefix removal, fast Fourier transforming, deinterleaving, decoding, and demodulation. In other wireless technology applications, yet other signal processing functions and combinations of signal processing functions may be performed by the DSP 802.

The DSP 802 may communicate with a wireless network via the analog baseband processing unit 810. In some embodiments, the communication may provide Internet connectivity, enabling a user to gain access to content on the Internet and to send and receive e-mail or text messages. The input/output interface 818 interconnects the DSP 802 and various memories and interfaces. The memory 804 and the removable memory card 820 may provide software and data to configure the operation of the DSP 802. Among the interfaces may be the USB interface 822 and the short range wireless communication sub-system 824. The USB interface 822 may be used to charge the UE 10 and may also enable the UE 10 to function as a peripheral device to exchange information with a personal computer or other computer system. The short range wireless communication sub-system 824 may include an infrared port, a Bluetooth interface, an IEEE 802.11 compliant wireless interface, or any other short range wireless communication sub-system, which may enable the UE 10 to communicate wirelessly with other nearby mobile devices and/or wireless base stations.

The input/output interface 818 may further connect the DSP 802 to the alert 826 that, when triggered, causes the UE 10 to provide a notice to the user, for example, by ringing, playing a melody, or vibrating. The alert 826 may serve as a mechanism for alerting the user to any of various events such as an incoming call, a new text message, and an appointment reminder by silently vibrating, or by playing a specific pre-assigned melody for a particular caller.

The keypad 828 couples to the DSP 802 via the interface 818 to provide one mechanism for the user to make selections, enter information, and otherwise provide input to the UE 10. The keyboard 828 may be a full or reduced alphanumeric keyboard such as QWERTY, Dvorak, AZERTY and sequential types, or a traditional numeric keypad with alphabet letters associated with a telephone keypad. The input keys may include a track wheel, an exit or escape key, a trackball, and other navigational or functional keys, which may be inwardly depressed to provide further input function. Another input mechanism may be the LCD 830, which may include touch screen capability and also display text and/or graphics to the user. The LCD controller 832 couples the DSP 802 to the LCD 830.

The CCD camera 834, if equipped, enables the UE 10 to take digital pictures. The DSP 802 communicates with the CCD camera 834 via the camera controller 836. In another embodiment, a camera operating according to a technology other than Charge Coupled Device cameras may be employed. The GPS sensor 838 is coupled to the DSP 802 to decode global positioning system signals, thereby enabling the UE 10 to determine its position. Various other peripherals may also be included to provide additional functions, e.g., radio and television reception.

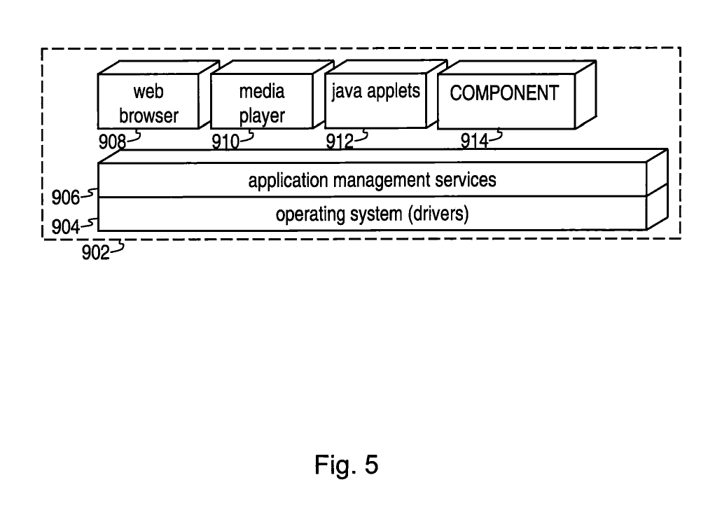

FIG. 5 illustrates a software environment 902 that may be implemented by the DSP 802. The DSP 802 executes operating system drivers 904 that provide a platform from which the rest of the software operates. The operating system drivers 904 provide drivers for the UA hardware with standardized interfaces that are accessible to application software. The operating system drivers 904 include application management services (“AMS”) 906 that transfer control between applications running on the UE 10. Also shown in the figure are a web browser application 908, a media player application 910, and Java applets 912. The web browser application 908 configures the UE 10 to operate as a web browser, allowing a user to enter information into forms and select links to retrieve and view web pages. The media player application 910 configures the UE 10 to retrieve and play audio or audiovisual media. The Java applets 912 configure the UE 10 to provide games, utilities, and other functionality. A component 914 might provide functionality described herein.

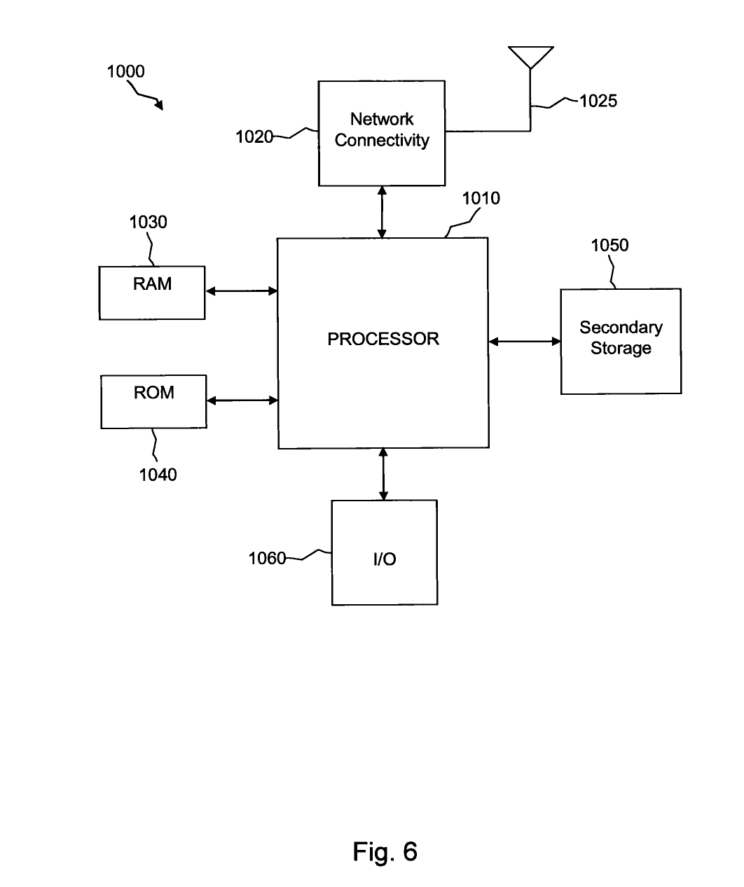

The UE 10, access device 120, and other components described above might include a processing component that is capable of executing instructions related to the actions described above. FIG. 6 illustrates an example of a system 1000 that includes a processing component 1010 suitable for implementing one or more embodiments disclosed herein. In addition to the processor 1010 (which may be referred to as a central processor unit (CPU or DSP), the system 1000 might include network connectivity devices 1020, random access memory (RAM) 1030, read only memory (ROM) 1040, secondary storage 1050, and input/output (I/O) devices 1060. In some embodiments, a program for implementing the determination of a minimum number of HARQ process IDs may be stored in ROM 1040. In some cases, some of these components may not be present or may be combined in various combinations with one another or with other components not shown. These components might be located in a single physical entity or in more than one physical entity. Any actions described herein as being taken by the processor 1010 might be taken by the processor 1010 alone or by the processor 1010 in conjunction with one or more components shown or not shown in the drawing.

The processor 1010 executes instructions, codes, computer programs, or scripts that it might access from the network connectivity devices 1020, RAM 1030, ROM 1040, or secondary storage 1050 (which might include various disk-based systems such as hard disk, floppy disk, or optical disk). While only one processor 1010 is shown, multiple processors may be present. Thus, while instructions may be discussed as being executed by a processor, the instructions may be executed simultaneously, serially, or otherwise by one or multiple processors. The processor 1010 may be implemented as one or more CPU chips.

The network connectivity devices 1020 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1020 may enable the processor 1010 to communicate with the Internet or one or more telecommunications networks or other networks from which the processor 1010 might receive information or to which the processor 1010 might output information.

The network connectivity devices 1020 might also include one or more transceiver components 1025 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1025 might include separate receiving and transmitting units or a single transceiver. Information transmitted or received by the transceiver 1025 may include data that has been processed by the processor 1010 or instructions that are to be executed by processor 1010. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1030 might be used to store volatile data and perhaps to store instructions that are executed by the processor 1010. The ROM 1040 is a non-volatile memory device that typically has a smaller memory capacity than the memory capacity of the secondary storage 1050. ROM 1040 might be used to store instructions and perhaps data that are read during execution of the instructions. Access to both RAM 1030 and ROM 1040 is typically faster than to secondary storage 1050. The secondary storage 1050 is typically comprised of one or more disk drives or tape drives and might be used for non-volatile storage of data or as an over-flow data storage device if RAM 1030 is not large enough to hold all working data. Secondary storage 1050 may be used to store programs that are loaded into RAM 1030 when such programs are selected for execution.

The I/O devices 1060 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 1025 might be considered to be a component of the I/O devices 1060 instead of or in addition to being a component of the network connectivity devices 1020. Some or all of the I/O devices 1060 may be substantially similar to various components depicted in the previously described drawing of the UE 10, such as the display 702 and the input 704.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for reducing congestion in a wireless communication network, the method comprising:
monitoring a congestion level of at least one network node of the network;
when the congestion level is greater than a first threshold, initiating a first congestion control mechanism; and
when the congestion level is greater than a second threshold, initiating a second congestion control mechanism, the second threshold being greater than the first threshold.

2. The method of claim 1, wherein the first congestion control mechanism includes codec rate adaptation (CRA).

3. The method of claim 1, wherein initiating the second congestion control mechanism includes at least one of rejecting new service requests and dropping existing services.

4. The method of claim 1, further comprising:
after initiating the first congestion control mechanism, starting a timer; and
when the timer reaches a pre-determined value and the congestion level is greater than the first threshold, initiating the second control mechanism.

5. The method of claim 1, wherein at least one of the first congestion control mechanism and the second congestion control mechanism are selected based upon a type of the at least one network node.

6. The method of claim 5, wherein:
when the at least one network node includes an access network node, at least one of the first and second congestion control mechanisms includes at least one of codec rate adaptation (CRA), conventional congestion control (CCC), quality of service (QoS) modification, and eNB load balancing; and
when the at least one network node includes a core network node, at least one of the first and second congestion control mechanisms includes at least one of selective Internet protocol (IP) flow traffic offloading (SIPTO), serving gateway (SGW) load balancing and packet gateway (PGW) load balancing.

7. The method of claim 1, including transmitting a codec rate adaptation (CRA) application type indicator, the indicator identifying a service type, and wherein initiating the first congestion control mechanism includes initiating congestion control of only services having a service type equal to the identified in the indicator.

8. A method for reducing congestion in a wireless communication network, the method comprising:
monitoring a congestion level of at least one network node of the network;
when the congestion level is greater than a first threshold:
initiating a first congestion control mechanism, and
starting a first timer; and
when the first timer reaches a first pre-determined value and the congestion level is greater than a second threshold, initiating a second congestion control mechanism, wherein the second threshold is less than the first threshold.

9. The method of claim 8, wherein the first congestion control mechanism includes codec rate adaptation (CRA).

10. The method of claim 8, wherein initiating the second congestion control mechanism includes at least one of rejecting new service requests and dropping existing services.

11. The method of claim 8, wherein at least one of the first congestion control mechanism and the second congestion control mechanism are selected based upon a type of the at least one network node.

12. The method of claim 11, wherein:
when the at least one network node includes an access network node, at least one of the first and second congestion control mechanisms includes at least one of codec rate adaptation (CRA), conventional congestion control (CCC), quality of service (QoS) modification, and eNB load balancing; and
when the at least one network node includes a core network node, at least one of the first and second congestion control mechanisms includes at least one of selective Internet protocol (IP) flow traffic offloading SIPTO, serving gateway (SGW) load balancing and packet gateway (PGW) load balancing.

13. The method of claim 8, including:
receiving a codec rate adaptation (CRA) application type indicator, the indicator identifying a service type, wherein initiating the first congestion control mechanism includes initiating congestion control of only services having a service type equal to the identified in the indicator.

14. A base station for reducing congestion in a wireless communication network, the base station comprising:
a processor configured to:
monitor a congestion level of at least one network node of the network;
when the congestion level is greater than a first threshold, initiate a first congestion control mechanism; and
when the congestion level is greater than a second threshold, initiate a second congestion control mechanism, the second threshold being greater than the first threshold.

15. The base station of claim 14, wherein the first congestion control mechanism includes codec rate adaptation (CRA).

16. The base station of claim 14, wherein the processor is further configured to:
after initiating the first congestion control mechanism, start a timer; and
when the timer reaches a pre-determined value and the congestion level is greater than the first threshold, initiating the second control mechanism.

17. The base station of claim 14, wherein at least one of the first congestion control mechanism and the second congestion control mechanism are selected based upon a type of the at least one network node.

18. The base station of claim 17, wherein:
when the at least one network node includes an access network node, at least one of the first and second congestion control mechanisms includes at least one of codec rate adaptation (CRA), conventional congestion control (CCC), quality of service (QoS) modification, and eNB load balancing; and
when the at least one network node includes a core network node, at least one of the first and second congestion control mechanisms includes at least one of selective Internet protocol (IP) flow traffic offloading (SIPTO), serving gateway (SGW) load balancing and packet gateway (PGW) load balancing.

19. A user equipment for reducing congestion in a wireless communication network, the user equipment comprising:
a processor configured to:
when a congestion level of at least one network node of the network is greater than a first threshold, implement a first congestion control mechanism; and
when the congestion level is greater than a second threshold, implement a second congestion control mechanism, the second threshold being greater than the first threshold.

20. The user equipment of claim 19, wherein at least one of the first congestion control mechanism and the second congestion control mechanism includes codec rate adaptation (CRA).
